(19) United States
(12) Patent Application Publication
(10) Pub. No.: US 2016/0207224 A1
(43) Pub. Date: Jul. 21, 2016

(54) MACHINE FOR CUTTING PRODUCTS IN SLAB FORM, PROTECTION DEVICE AND OPERATING METHOD

(71) Applicant: BRETON SPA, Castello di Godego (TV) (IT)

(72) Inventors: Dario Toncelli, Bassano del Grappa (VI) (IT); Renzo Codemo, Villa d'Asolo - Asolo (Treviso) (IT)

(21) Appl. No.: 15/024,057

(22) PCT Filed: Sep. 24, 2014
(86) PCT No.: PCT/IB2014/064794

§ 371 Date: Mar. 23, 2016

(30) Foreign Application Priority Data
Sep. 30, 2013 (IT) TV2013A000153

(51) Int. Cl. B28D 7/04; B28D 1/04

(52) U.S. Cl. CPC B28D 7/046; B28D 1/043

(57) ABSTRACT

A machine (10) for machining materials in slab form (14) comprises a working surface (13), a cutting spindle (12) on which a cutting disc (22) is mounted, motor means (11) for moving the cutting spindle on the working surface, controlled by an electronic control system (23). The cutting spindle (12) is rotatable about an axis (21) so as to move upon command between a first position in which the cutting disc (22) is perpendicular to the working surface, and a second position in which the cutting disc (22) is parallel to the working surface. The cutting spindle (12) has a protection device (26) which covers at least partially the cutting disc and which comprises a pick-up element (27) with a surface (28) provided with sucker means (29) able to cause said device (26) to adhere and be fixed to the materials being machined on the working surface when the cutting spindle (12) is in the second position, so that the material can be moved on the working surface by moving the cutting spindle (12). The said pick-up element (27) is resiliently movable with respect to the protection device in the direction of action of the sucker means.

The present invention relates to a machine for cutting products in slab form, such as natural or agglomerated stone materials, ceramic materials, glass materials, etc., and provided with integrated devices for handling the material being machined. The invention also relates to an operating method of the machine and to a device for protecting the cutting disc of a machine for cutting and machining slabs.

Cutting machines provided with sucker devices arranged on the side of the disc protection cover for picking up the cut slab parts and moving them on the working surface of the machine are known.

One of these machines is for example described in international patent application WO2011/145005. In this document it is described a machine provided with a cutting spindle where the cutting disc is protected by a disc protection cover with integrated sucker means. The suckers are activated after the cutting spindle has rotated through 90° so that the disc protection cover passes from a vertical position to a horizontal position facing the slab to be moved.

WO 2011/144270 also describes a machine with handling means having suckers arranged on the cutting head.

The known solutions have a number of problems which generally arise during the approach movement of the sucker means towards the material to be moved, owing to the possible impacts of the pick-up device against the surface of the slab and/or the machining surface.

In fact, even if the movement of the machining head is very precise, owing to possible roughness of slab material it is not always possible to perform the approaching movement without impacts and/or with a firm gripping action of the sucker means.

In the event of a programming error of the machine, malfunctioning of its components or defects in the material being machined, the disc protection cover may hit the material violently, resulting in serious damage not only to the sucker-carrying cover, but also to the structure of the machine. Furthermore, even when the movement is correct, the contact between suckers and material may be brusque (despite a slow speed of the approach movement towards the material) owing to the rigid nature of the system.

These problems are only partly offset by the resilience of the rubber gaskets which form the suckers.

Moreover, if the slab has surface rougness or is not perfectly flat, there may be difficulties in picking up the material. Even more particularly, if the slab has obvious roughness or is relatively high planarity errors , it is not possible to engage it and pick it up. In an attempt to ensure a firm grip in some cases it is attempted to increase the thrusting force moving the suckers towards the slab, but this may increase the problems of an unwanted impact.

The solution to the problem is complicated by the fact that the space available on the disc protection cover is limited and cannot be increased excessively without adversely affecting the free movement of the cutting head, which it is preferable should occupy a minimum volume in the vicinity of the cutting disk.

In an attempt to overcome the problem, at present proximity sensors are used, arranged in the zone of the suckers and being able to detect the presence of the approaching slab. These sensors have the function of detecting the instant when the distance from the slab is less than a predetermined value, stopping the movement of the cutting head carrying the suckers and then activating the vacuum system in order to pick up the material. However, these sensors are not always effective, in particular when the slab has roughness which may affect detection. For example, if the sensors do not detect the slab owing to excessive roughness, even when situated only in the area where the sensors are located, the head continues its approach movement until an undesirable impact, which may be violent, occurs. Moreover, planarity errors of the slab may in any case adversely affect the adhesive force of the suckers, with the result that the slab cannot be picked up.

A general object of the present invention is to provide a protection element and a cutting machine, with incorporated sucker means for picking up the material being machined, which allow the material to be approached in a gentle and gradual manner, avoiding relatively violent impacts of the sucker means. A further object is to achieve this without increasing in an unacceptable manner the dimensions of the protection device carrying the sucker means.

In view of these objects the idea which has occurred, according to the invention, is to provide a machine for machining materials, comprising a working surface, a cutting spindle on which a cutting disc is mounted, motor means for moving the cutting spindle on the working surface, controlled by an electronic control system, the cutting spindle also being rotatable about an axis so as to move upon command between a first position in which the cutting disc is perpendicular to the working surface, and a second position in which the cutting disc is parallel to the working surface, the cutting spindle having a protection device which covers at least partially the cutting disc and which comprises a pick-up element with a surface provided with sucker means able to cause said device to adhere and be fixed to the materials being machined on the working surface when the cutting spindle is in the second position, so that the material can be displaced on the working surface by moving the cutting spindle, characterized in that said pick-up element is resiliently movable with respect to the protection device in the direction of action of the sucker means.

The idea which has also occurred is to provide a method for picking up and displacing slab of material on the working surface of a machine provided as described above, comprising the steps of rotating the cutting spindle from the first to the second position, and operating the motor means for the movement of the cutting spindle towards the material on the working surface so as to rest the sucker means on the material with a resilient movement of the pick-up element.

The idea which has also occurred is to provide a protection device for a cutting disc intended to be mounted on a cutting spindle of a machine tool for machining and cutting materials, so that it covers at least partially the cutting disc, and provided with a pick-up element from which sucker means project able to cause said pick-up element to adhere and be fixed to the materials being machined, characterized in that said pick-up element is resiliently movable in the direction of action of the sucker means.

In order to illustrate more clearly the innovative principles of the present invention and its advantages compared to the prior art, examples of embodiment applying these principles will be described below with the aid of the accompanying drawings. In the drawings:

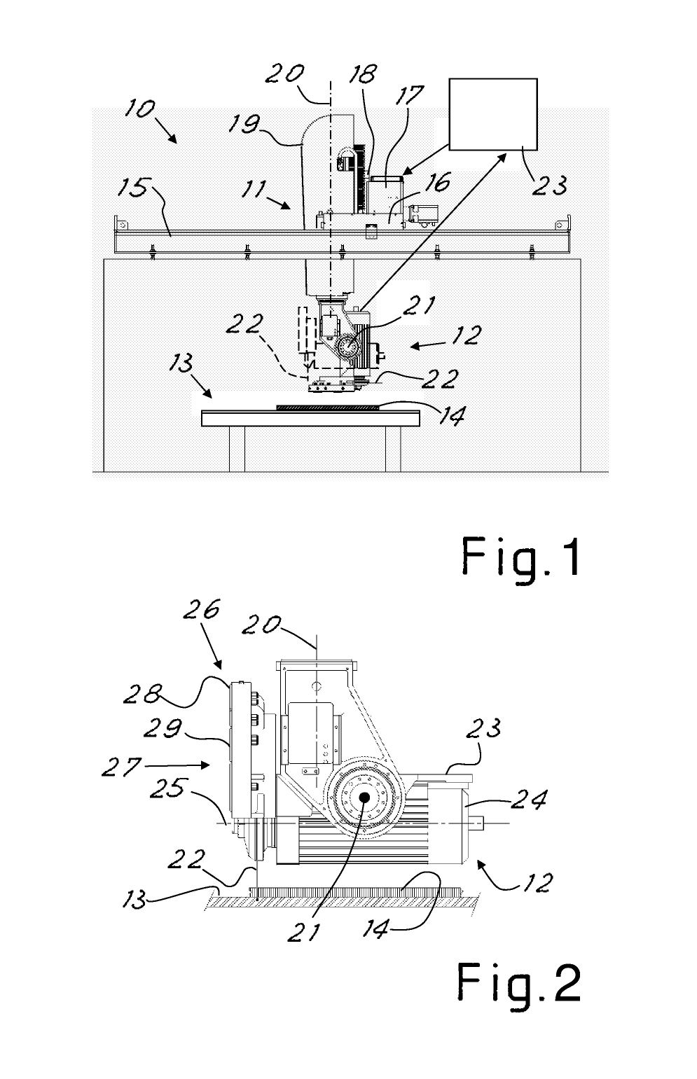

FIG. 1 shows a schematic front elevation view of a cutting machine according to the invention;

Figures shows a view, on a larger scale, of the cutting head of the machine according to FIG. 1;

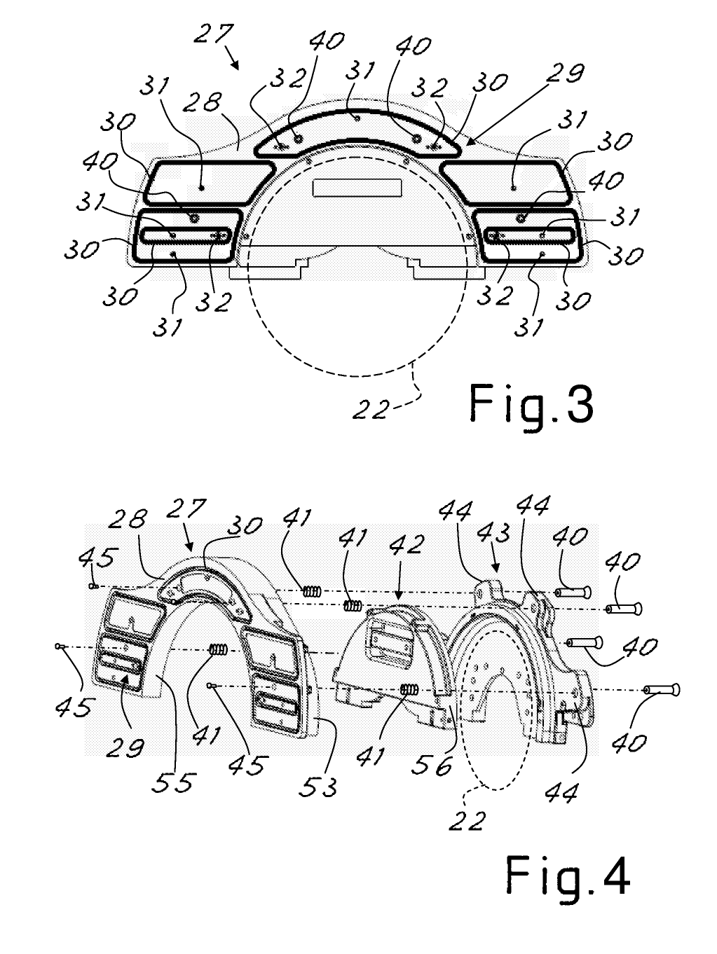

FIG. 3 shows a front view of a protection device for the cutting disc of the machine according to the invention;

FIG. 4 shows a schematic exploded view of a protection device for the cutting disc of the machine according to the invention;

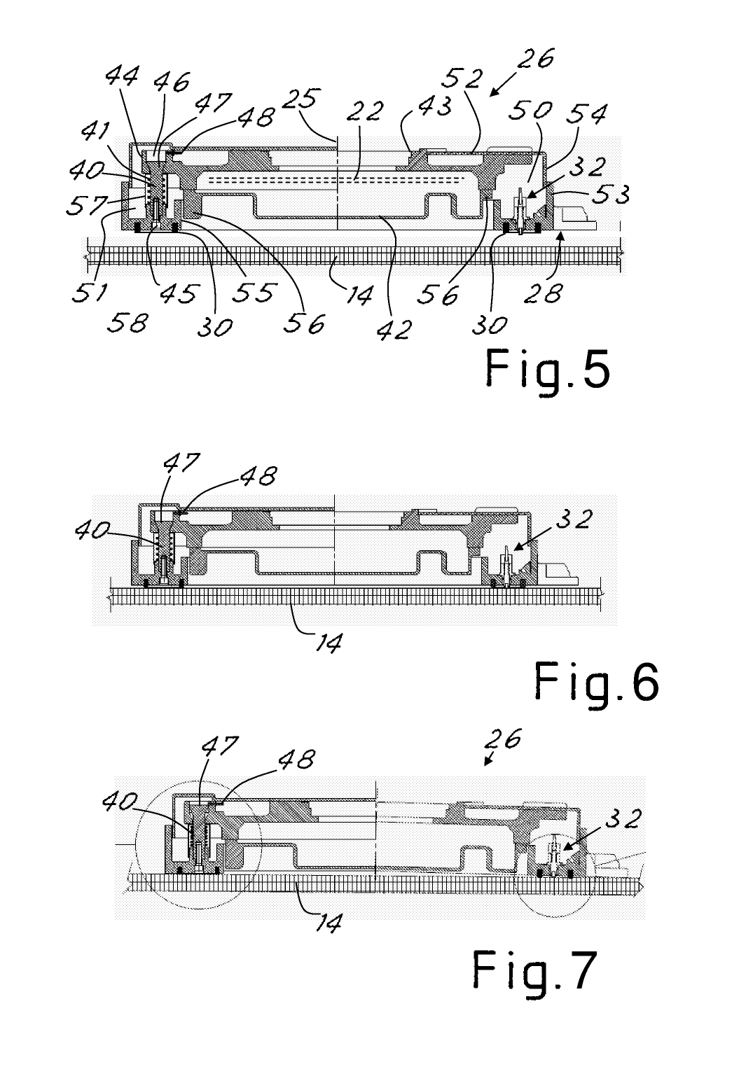

FIGS. 5, 6 and 7 are schematic cross-sectional views of a protection device according to the invention during the approach movements towards a slab being machined;

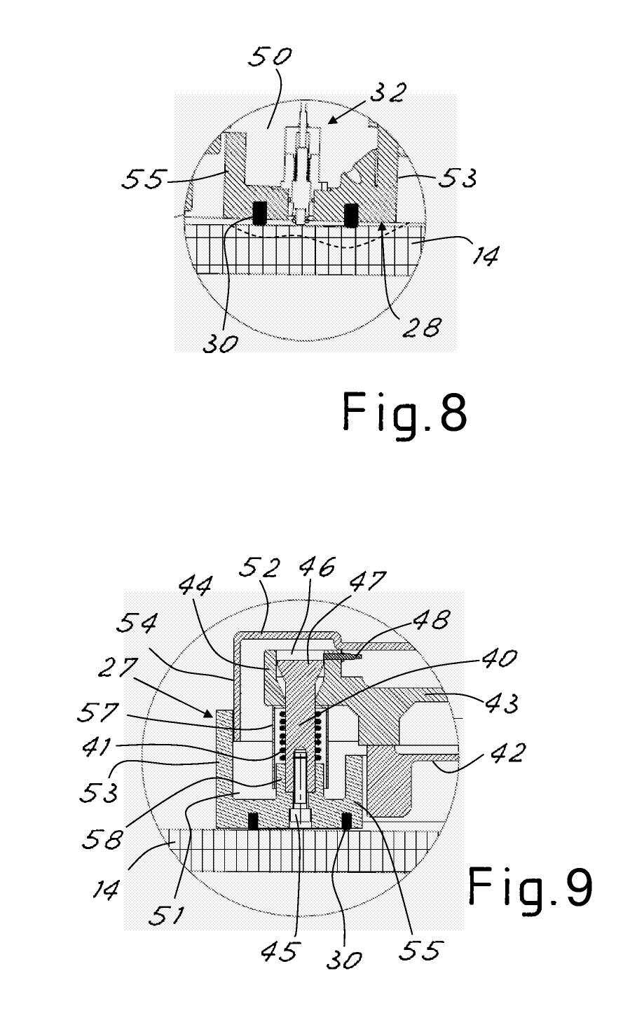

FIGS. 8 and 9 show schematic views on a larger scale of details according to FIG. 7;

With reference to the figures, FIG. 1 shows a cutting machine for machining materials in slab form, realized in accordance with the principles of the invention and indicated generally by 10.

The machine 10 comprises motor means 11 for moving a cutting spindle 12 on top of a working surface 13 on which the slab of material 12 to be machined is arranged.

The movement means are advantageously of the Cartesian type with a movement Y-Y parallel to the working surface and a movement Z perpendicular to this surface. These movement means are substantially of the known type and will not be further described or shown, being able to be easily imagined by the person skilled in the art. They usually comprise guides for the sliding, along the axes of motor-driven carriages supporting the cutting spindle, such as to be able to position the spindle at any point in a predefined given space above the working surface. The spindle 12 is also rotatable about an axis 20 substantially coinciding or at least parallel with the movement axis Z.

By way of example, in FIG. 1 it is shown a possible Cartesian movement structure with transverse guides 15 (generally these guides are two in number and parallel to each other) along which a first motor-driven carriage 16 slides, said carriage supporting longitudinal guides 17 on which in turn a second motor-driven carriage 18 slides. A sleeve 19 slides vertically on the second carriage and at the bottom supports a cutting head on which a spindle 12 is mounted. It is thus possible to perform said Cartesian movement along three axes.

The spindle 12 supported by the movement means is provided rotatably around a motor-driven axis 21 (advantageously parallel to the working surface) so as to be able to move between a first position (shown in broken lines in FIG. 1), where a cutting disc 22, operated by the spindle motor, is perpendicular to the machining surface 13 for example in order to perform cuts in the material, and a second position (shown in solid lines in FIG. 1), where the cutting disc 22 is substantially parallel to the working surface 13.

The movement means 11 (as well as other machine functions and operations) are controlled by an electronic control system 23 (for example a suitably programmed microprocessor unit) of the type known per se and easily able to be imagined by the person skilled in the art. The electronic system allows for example a preset cutting program to be carried out, causing the cutting disc to follow the desired trajectories above and inside the material 14 being machined.

In FIG. 2 it is shown in greater detail a possible embodiment of the cutting head. In this embodiment the head may advantageously comprise a frame 23 which is pivotably mounted on the axis 21 so as to be rotatable, upon command, between the said first and second positions. A cutting spindle 12 comprising a spindle motor 24 for rotation of the cutting disc 22 about its axis 25 is mounted on the frame. In an alternative embodiment, the spindle motor may in any case be in another part of the machine and be connected to the cutting disc by means of suitable known kinematic transmissions.

The cutting disc 12 is provided with a protection device 26 which covers partially the cutting disc, so that only one operating segment of the disc is exposed, as normal in cutting machines of this type. As can be seen in FIG. 2, this operating part may be advantageously located in the bottom half of the circumference of the disc.

The protection device 26 comprises a pick-up element 27 with surface 28 (advantageously parallel to the surface of the disc and opposite to the rotating motor 24) provided with sucker means 29 able to cause the device to adhere and be fixed to the materials being machined on the working surface when the cutting spindle is in the second position.

In this way, when the spindle is brought into the second position and the surface 28 is made to adhere with the sucker means to the material 14, the movement performed by the cutting spindle may displace the materials on the working surface.

As will become clear below, the surface 28 is designed to be movable resiliently on the protection device 26 in the general direction of action of the sucker means 29, so as to be able to retract when pushed against an obstacle owing to the movement of the cutting head towards the working surface and the material to be picked up. Usually the direction of the action of the sucker means may be considered to be perpendicular to the plane containing these sucker means and coincides in practice with the direction in which the sucker means approach the surface of the material to be picked up. In the machine described it may be substantially parallel to the axis Z or to the axis 20.

In order to be resiliently movable, the pick-up element is advantageously connected to the remainder of the protection device via resilient means. In other words a device which is advantageously divided into a disc protection part and a resiliently supported pick-up part is provided.

In FIG. 3 it is shown the front view of a possible advantageous embodiment of the protection device with the surface 28 provided with the sucker means 29.

In this front view it can be seen that the approach surface 28 is provided with the controlled sucker means 29. These sucker means comprises advantageously a plurality of yielding gaskets 30 which form the edges of the suction pads and which project from the surface 28 so as to provide a seal against the material to be moved. Suction ducts 31 which are connected to a controlled vacuum source of the machine emerge inside the surface parts surrounded by the gaskets.

As can be seen in FIG. 3, advantageously gaskets 30 contained in the area surrounded by other larger-size gaskets 30 may also be provided, so as to form smaller suckers inside larger-size suckers. This allows easy adhesion also to small-size surfaces.

Advantageously, the pick-up element 27 has a surface with the sucker means 29 which has a general C shape about the axis 25 of rotation of the cutting disc. Preferably, the size of the empty central part of the C corresponds to that of the cutting disc (shown schematically in broken lines in FIG. 3) so as not to cover it, for the reasons which will be clarified below.

In the embodiment shown in FIG. 3, the C-shaped pick-up element has advantageously arms which extend on the two sides of the cutting disc, with an upper connecting section. Again advantageously, in each elongated side arm there are two large sucker zones (namely zones surrounded by the respective gaskets 30), while in the upper section there is an elongated and curved sucker zone. In the bottom sucker of each side there is moreover a second innerlying gasket forming a sucker zone with a smaller area, for the purpose already mentioned above.

The surface 28 of the protection device 27 according to the invention is advantageously provided with proximity sensors 32 which are designed to detect the approaching movement of the surface 28 with the sucker means towards a facing surface and, in particular, towards the surface of the material being machined. The approach movement indicated may be of the on/off type, with the sensors which sense only when there is correct contact of the sucker means on a surface to be picked up, or the sensors may be of the type which provide a signal proportional to the distance from the surface to be picked up, starting from a maximum predefined distance as far as the contact point.

The proximity sensors may of different known types, such as inductive, capacitive, magnetic, optical, etc. Advantageously, they may also be of the electromechanical type with a feeler finger which projects from the surface 28 and which, when pressed, against the action of a suitable spring, actuates an electric contact. A similar structure is shown in the drawings.

The sensors 32 are connected to the control system 23 in order to signal to it the approaching condition and, preferably, when contact has occurred.

Preferably, these sensors consist of a plurality and are contained in at least some of the suckers, namely in at least some of the surface parts 28 which are surrounded by the gaskets 30 for forming the suckers.

For example, the proximity sensors 32 may be four in number (as shown in FIG. 3) distributed symmetrically with respect to a vertical plane passing through the axis of rotation of the cutting disc. Preferably, with a sucker distribution similar to that shown in FIG. 3, the sensors may be two in number situated at the ends of the upper elongated sucker and one inside each smaller concentric sucker on the side arms of the C.

For the objects which will become clear below, at least one limit sensor is also present, being connected to the electronic control system 23 so as to send to the said electronic control system a limit signal activated by the movement of the pick-up element 27 with respect to the protection device in the event of a stroke greater than a predetermined stroke.

Preferably, these limit sensors may be distributed over the surface 28 of the pick-up element 27 so that they may also be activated by any movements of the surface 28 which are not parallel to the plane of the cutting disc, as will be clarified below.

FIG. 4 shows an exploded view of an advantageous embodiment of the protection device with the sucker means. In this embodiment the resilient means which allow the pick-up element 27 to be moved resiliently with respect to the remainder of the protection device comprise a plurality of sliding pins 40, which form a sliding connection, and springs 41 which resiliently oppose the movement of the pick-up element on the pins and towards the remainder of the protection device. Preferably, the springs are of the helical type and are fitted onto the pins.

Advantageously, the protection device 26 comprises a pair of half-shells, namely a front half-shell 42 and a rear half-shell 43, which are connected together and which cover the two sides of the cutting disc (schematically shown in broken lines in FIG. 4) over a part of its circumference.

The surface 28 of the pick-up element 27 is instead preferably part of a generally C-shaped element which forms the sucker-carrying cover and is provided with seats for the proximity sensors.

Again advantageously, the pick-up element 27 surrounds at least partially the front half-shell 42 and slides around it with a resilient movement in the direction of action of the sucker means.

The front half-shell 42 is advantageously fixed onto the rear half-shell 43 independently of the pick-up element 27 so that it is possible to remove it in order to expose frontally the cutting disc and allow access thereto, for example, for maintenance or replacement operations, without the need for disassembly of the pick-up element 27.

In the advantageous structure shown, the pins 40 are connected between lugs 44, radially projecting from the protective half-shells (preferably from the rear half-shell 43), and the pick-up element 27. In this way the pins pass through the sides of the front half-shell, as can be clearly seen in FIG. 4.

As can be clearly seen in FIG. 5 and in an enlarged detail shown in FIG. 9, during the formation of the resilient means by means of pins and springs, the pins have advantageously a first end which is fixed to the pick-up element (for example by means of a fixing screw 45) and slide axially inside seats 46 formed in the protection device 26 (for example formed in parts of the rear half-shell which radially project with respect to the front half-shell 42, as in the embodiment shown in FIG. 4).

The pins 41 are advantageously distributed over the pick-up element 27 so as to allow a suitable resilient movement of the element, without jamming or slipping.

As can be clearly seen in FIG. 5 and in particular in FIG. 9, at least one pin has advantageously a first end fixed to the pick-up element and a second end 47, opposite to the first end, which is detected by a sensor 48 which thus forms the limit sensor which sends the limit signal to the electronic control system 23. The sensor 48 may be a proximity sensor (inductive, capacitive, etc.) of the contactless type or may comprise a microswitch activated by contact with the end of the pin.

In this embodiment, the limit signal is sent when the pin 40 retracts inside its sliding seat by the maximum predetermined amount for the resilient movement of the pick-up element 27.

As can be clearly seen in FIG. 9, the end 47 of the pin may be radially wider so as to form also a mechanical limit stop on the bottom of the corresponding seat 46 in the thrust direction of the springs. The bottom of the seat and the corresponding facing surface of the wider end may also be conical so that their position may be suitably adapted.

As can be clearly seen in FIG. 5, the sensors 32 and the pins 40 are housed inside recesses 50, 51 formed in the periphery of the pick-up element 27 and the half-shells 42, 43. A housing 52 may also be provided in order to isolate these recesses from the outside and protect the sensors and the resilient movement mechanism. As can be seen again in FIG. 5, in an advantageous embodiment the free movement is allowed owing to the mutual “telescopic” sliding movement—with a small amount of play and in the direction of the resilient movement—of a perimetral rear edge 53 of the pick-up element 27 on a corresponding front perimetral edge 54 of the housing 52.

The inner side of the pick-up element 27 may be provided with a corresponding mutual “telescopic” sliding movement, also with a small amount of play, in the direction of the resilient movement, between an inner perimetral edge 55 (advantageously directed towards the rear) of the pick-up element 27 and a corresponding outer perimetral edge 56 (which may be ribbed) of the front shell 42.

In the case of helical springs arranged coaxially on the pins, protection tubes or cylinders 57 may also be provided, these being arranged coaxially around the springs. An end-piece 58 projecting from the pick-up element 27 may also advantageously slide inside the cylinders 57 so as to act as a guide for the cylinder around the respective pin.

The preferred structure described above for the protection device, with sliding “telescopic” parts between pick-up element 27 and protective shells 42, and optionally spring protection cylinders 57, enables efficient sliding and dampened operation to be achieved also in particularly critical slab cutting conditions where dust is generated and coolants which act on the cutting disc protection device are used.

During use of a machine according to the invention, when it is required to perform picking up of the material being machined on the working surface 13, the control system rotates the spindle into the second position and moves the pick-up element towards the machining surface.

In FIG. 6 it is shown a first example of the surface 28 with the sucker means moved up fully against the surface of the material being machined.

In the fully approached condition, the sucker means come into contact with the part to be picked up and may be activated for the pick-up operation. The resilient support system of the pick-up element 27 compensates for any small differences in the evenness and position and allows pick-up to be performed without impacts. For example by making use of the resilient movement it is possible to continue the movement towards the surface of the slab to be picked up over a small distance after contact, so as to ensure that the sucker means fit properly against this surface.

With the embodiment of the invention comprising proximity sensors and limit sensors further advantages during the control of the approach and pick-up operations may be obtained.

In fact, by using the sensor signals and in particular the combination of proximity and limit sensors, the control system may obtain further information about the approach and pick-up operations and provide a more intelligent pick-up method which may make optimum use of the presence of the resilient support.

In this case, the sucker-carrying cover may be moved towards the material to be picked up as already described above, if necessary with slight adaptation of the pick-up element by the resilient means, and as soon as a proximity sensor detects the presence of the material (which may have an area smaller than the extension of the surface 28), the control system stops the movement of the spindle and activates the vacuum system so as to engage with the slab and pick it up. In this condition, the limit sensors, where present, will not intervene.

If the surface 28 of the pick-up element is parallel to the facing surface of the material to be picked up and the slab is substantially flat and does not have any significant surface roughness, or the lack of flatness and the roughness is such that it may be compensated for by the resilient movement according to the invention, at least one proximity sensor is activated before there is no more possibility for resilient movement of the pick-up element 27.

In FIG. 7 it is shown instead the limit condition of a slab with an upper surface which is excessively not flat and/or has excessive surface roughness.

In this case, with the approaching movement of the spindle, the pick-up element 27 makes contact with the material to be picked up, but the proximity sensors do not detect the presence of the material, despite the possibility of the resilient adjusting movement. The situation is shown more clearly in the larger scale view of FIG. 8.

The movement of the spindle therefore continues until the (or at least one) limit sensor intervenes. The situation is shown more clearly in the larger-scale view of FIG. 9.

The corresponding limit signal reaches the control system 23 which stops operation of the machine since it is not possible to move the suckers towards the slab correctly and therefore it is not possible to pick it up.

At this point it is clear how the predefined objects have been achieved.

For example, from the description provided above it is clear how a solution according to the invention is efficient and reliable and how with the present invention it is possible to pick up slabs which also have substantial surface roughness or flatness errors which can be compensated for by the resilient system according to the invention.

Moreover, in the case for example of human error or malfunctioning of the machine and, therefore, should the pick-up element 27 with the incorporated sucker means be erroneously moved too quickly towards the material or towards an obstacle, owing to the resilient devices the impact would in any case be dampened, thus preserving the functionality not only of the device, but also of the entire machine.

Moreover, it is now clear how, with the principles of the present invention, it is possible to obtain dimensions of the protection device which are limited in a satisfactory manner also with an incorporated pick-up system and how it is possible to provide a device which may be easily assembled and disassembled and allows easy and rapid access to the cutting disc. The machine thus has a high operational capacity and flexibility.

Another aspect of the invention is that the protection device according to the invention may also continue to protect effectively the cutting disc despite its resilient movement.

In the preferred embodiment provided with proximity and limit sensors it is also possible to limit the movement allowed by the resilient means so as to keep the overall dimensions of the pick-up element 27 small in the direction of axis of the spindle, while still ensuring effective compensation of defects or errors in the approach movement and safe stopping of the machine in the event of a too fast an approach movement towards the surface to be picked up.

Obviously the description provided above of embodiments applying the innovative principles of the present invention is provided by way of example of these innovative principles and must therefore not be regarded as limiting the scope of the rights claimed herein.

For example, although limits sensors which use the movement of the sliding sensors as described above have been found to be particularly advantageous, different sensors may also be used, such as distance sensors which detect the position of the pick-up element with respect to the remaining part of the cutting disc protection device, or similar solutions, which may now be easily imagined by the person skilled in the art.

According to a particularly compact structure the pick-up element surrounds at least partially a disc protection casing and is fastened to it by resilient means arranged around the periphery of the disc protection casing.

However, it is possible to imagine other structures, while remaining within the scope of protection claimed here. Moreover, it is also to imagine a resilient support structure different from the structure with pins and springs, arranged coaxially or not, as may be easily imagined by the person skilled in the art.

1. A machine (10) for machining materials (14), comprising a working surface (13), a cutting spindle (12) on which a cutting disc (22) is mounted, motor means (11) for moving the cutting spindle on the working surface, controlled by an electronic control system (23), the cutting spindle (12) also being rotatable about an axis (21) so as to move upon command between a first position in which the cutting disc (22) is perpendicular to the working surface, and a second position in which the cutting disc (22) is parallel to the working surface, on the cutting spindle (12) being present a protection device (26) which covers at least partially the cutting disc and which comprises a pick-up element (27) with a surface (28) provided with sucker means (29) able to cause said device (26) to adhere and be fixed to the materials being machined on the working surface when the cutting spindle (12) is in the second position, so that the materials can be moved on the working surface by moving the cutting spindle (12), characterized in that said pick-up element (27) is resiliently movable with respect to the protection device in the direction of action of the sucker means.

2. Machine according to claim 1, characterized in that said pick-up element (27) is mounted on the remaining part of said protection device (26) with the arrangement of resilient means (40, 41) in between.

3. Machine according to claim 1, characterized in that on the surface (28) provided with sucker means (29), proximity sensors (32) are present connected to said electronic control system (23) so as to send to said electronic control system a signal for contact of the sucker means with the material on the surface, and it is present at least one limit sensor (48) connected to said electronic control system (23) so as to send to said electronic control system a limit signal activated by the movement of said pick-up element (27) with respect to the remaining part of the protection device in the event of a stroke greater than a predetermined stroke.

4. Machine according to claim 1, characterized in that the protection device (26) comprises a front half-shell (42) and a rear half-shell (43) coupled together so as to cover at least partially the two sides of the cutting disk, the pick-up element (27) surrounding at least partially the front half-shell (42) and being connected to the rear half-shell (43) by resilient means (40, 41).

5. Machine according to claim 1, characterized in that said pick-up element (27) is resiliently movable with respect to said protection device (26) by means of a plurality of sliding pins (40) and springs (41) for resiliently opposing the movement of said pick-up element (27) towards the protection device.

6. Machine according to claim 5, characterized in that the pins (40) have a first end fixedly connected to the pick-up element (27) and slide axially in seats (46) in the protective device (26).

7. Machine according to claims 4 and 6, characterized in that the seats (46) are formed in parts (44) of the rear half-shell (43) which are radially projecting with respect to the front half-shell (42).

8. Machine according to claim 4, characterized in that the front half-shell (42) is fixed on the rear half-shell (43) independently of the pick-up element (27) so as to be removable from the rear half-shell (43) and uncover frontally the cutting disc (22) without the need for disassembly of the pick-up element (27).

9. Machine according to claims 3 and 6, characterized in that at least one pin (40) has one end (47), opposite to said first end, which during its sliding movement in the seat (46) is detected by the limit sensor (48) so as to send the limit signal to said electronic control system (23).

10. Machine according to claim 1, characterized in that the pick-up element (27) has the surface (28) with sucker means (29) which has a generally C-shape around a rotation axis of the cutting disc.

11. Machine according to claim 1, characterized in that the sucker means (29) comprise peripheral yielding gaskets (30) which project from said surface (28) and border a part of said surface and are intended to provide a seal against the material to be handled, the bordered parts of the surface having suction ducts (31) connected to a controlled vacuum source.

12. Machine according to claims 3 and 11, characterized in that at least some bordered parts of the surface contain the said proximity sensors (32).

13. Method for picking up and displacing a slab of material on the working surface of a machine provided according to any one of claims 1 to 12, comprising the steps of rotating the cutting spindle from the first to the second position, operating the motor means (11) for the movement of the cutting spindle (12) towards the material on the working surface so as to rest the sucker means (29) on the material with a resilient movement of the pick-up element.

14. Method according to claim 13, wherein steps for controlling the emission of signals of proximity sensors (32) and at least one limit sensor (48) located on the protection device (26) are performed so that: if a proximity sensor (32) detects the proximity with the material, the sucker means are activated and the pick-up operation is performed with displacement of the material by means of the movement of the cutting head spindle, or, if the limit sensor detects a limit condition corresponding to a resilient movement of the said surface greater than a predetermined stroke, the movement of the cutting spindle towards the material on the working surface is interrupted.

15. Method according to claim 14, wherein if the limit sensor detects the limit condition the machine emits an error signal.

16. Protection device (26) for ,a cutting disc intended to be mounted on a cutting spindle of a machine tool for machining and cutting material, so that it covers at least partially the cutting disc, and comprising a pick-up element (27) provided with sucker means (29) able to cause said pick-up element (27) to adhere and be fixed to the materials being machined, characterized in that said pick-up element (27) is resiliently movable in the direction of action of the sucker means (29).

17. Protection device according to claim 16, characterized in that it comprises proximity sensors (32) which detect the proximity of the sucker means (29) to a surface of the material being machined and onto which they must adhere and at least one limit sensor (48) which is activated by a movement of said resiliently movable pick-up element (27) in the event of a stroke greater than a predetermined stroke.
